(19) United States
(12) Patent Application Publication
(10) Pub. No.: US 2005/0142382 A1
(43) Pub. Date: Jun. 30, 2005

(54) Organic EL panel and method of manufacturing the same

(75) Inventors: Michio Menda, Yamagata-ken (JP); Masanori Suzuki, Tokyo (JP)

Correspondence Address: ARENT FOX PLLC, 1050 CONNECTICUT AVENUE, N.W., SUITE 400, WASHINGTON, DC, 20036, US

(73) Assignees: Tohoku Pioneer Corporation; JSR Corporation

(21) Appl. No.: 11/019,247

(22) Filed: Dec. 23, 2004

(30) Foreign Application Priority Data
Dec. 24, 2003 (JP) 2003-427293

(51) Int. Cl. H05B 33/04; H05B 33/10

(52) U.S. Cl. 428/690; 428/917; 428/76; 428/68; 313/504; 313/512; 257/100; 156/67

(57) ABSTRACT

An organic EL panel formed by interposing a resin layer between a sealing cover and a substrate on which an organic EL device section has been formed, making it possible to dispense with a hardening treatment of the resin layer, thereby avoiding an organic EL device deterioration possibly caused by the hardening treatment and at the same time simplifying the manufacturing process. A substrate on which an organic EL device section has been formed, is bonded with a sealing cover which if necessary is provided with a desiccating member, through the resin layer interposed therebetween. The resin layer is formed of a high molecular elastomer, making it possible to dispense with the hardening treatment of the resin layer.

### BACKGROUND OF THE INVENTION

The present invention relates to an organic EL panel and a method of manufacturing the same.

The present application claims priority from Japanese Applications No. 2003-427293, the disclosures of which are incorporated herein by reference.

An organic EL (Electroluminescence) panel comprises a substrate, one or more organic EL devices each including a pair of electrodes and an organic material layer containing a luminescent functional layer, with the organic material layer interposed between the electrodes, thereby forming a display area by arranging the one or more organic EL devices. However, with regard to such an organic EL panel, once the organic material layer and the electrodes are exposed to the outside air, the luminescent characteristics of the organic EL device(s) will get deteriorated. To prevent such deterioration, it is indispensable to provide a sealing cover to protect the organic EL device(s) from the outside air. Accordingly, it is usual to bond the sealing cover onto the substrate (on which the organic EL device(s) have already been formed) in a manner such that the substrate can be covered up by the sealing cover, with the organic EL device(s) disposed within a sealed space formed between the substrate and the sealing cover.

In view of the above, Japanese Unexamined Patent Application Publication Nos. 8-236271 and 2002-216950 have disclosed a technique of filling the above-mentioned sealed space with a resin layer. In particular, Japanese Unexamined Patent Application Publication No. 8-236271 discloses that layers constituting organic EL device(s) are laminated on a substrate, while a protection layer, a sealing layer, and an outside air interception layer are formed on the external surface of the organic EL device(s), with a sealing material used in the sealing layer being an elastic adhesive which is a sort of modified silicone. Further, Japanese Unexamined Patent Application Publication No. 2002-216950 discloses that when organic EL device(s) and a sealing cover are to be bonded together through a resin layer, resin is applied to several positions on the organic EL device(s), followed by pressing the resin material by means of the organic EL device(s) and the sealing cover, thereby forming an integrally laminated body. Here, the resin material is a light-setting resin.

However, with regard to the above-discussed conventional technique, if a resin layer is interposed between a sealing cover and a substrate on which organic EL device(s) have been formed, an internal clearance formed within an internal space can be eliminated, thus making it possible to reduce an amount of an initial moisture existing within the internal space, thereby making it possible to reduce an amount of a desiccating agent which is necessary to be disposed within the internal space. On the other hand, with regard to a top-emission type display panel which emits light from the sealing cover side, it is possible to adjust, by adjusting the resin layer, the refraction index of a light path extending through the sealing cover from the light emission surface of organic EL device(s), whereby an advantage may be obtained which makes it possible to prevent an aperture deviation between the light emission surface of the organic EL device(s) and the sealing cover.

However, in using the above-discussed conventional technique, if the resin layer is formed by a reactive polymer which is then hardened after being sealed by a sealing cover, there is a possibility that the organic EL device(s) might get deteriorated due to heat or light which is applied for hardening the reactive polymer, resulting in a problem that un-reacted components (such as monomers or the like) can act as organic EL device deterioration factors and remain in the resin composition staying within the internal space. Moreover, since it is necessary to carry out a step of hardening the resin layer, it is difficult to simplify the entire manufacturing process.

### SUMMARY OF THE INVENTION

To solve the above-mentioned problem is one of several tasks of the present invention. Namely, it is an object of the present invention to provide an improved organic EL display panel comprising a substrate on which organic EL device(s) have been formed, and a sealing cover, with a resin layer interposed therebetween, by omitting a resin layer hardening process so as to avoid the deterioration of the organic EL device(s) which is possibly caused due to such hardening treatment, thereby simplifying the manufacturing process and eliminating some organic EL device deterioration factors remaining within the internal space of the display panel.

In order to achieve the above object of the present invention, an organic EL display panel and a method of manufacturing the organic EL display panel according to the present invention are characterized in the following aspects.

Namely, according to one aspect of the present invention, there is provided an organic EL panel including at least one organic EL device formed by interposing an organic material layer containing a luminescent functional layer between at least one pair of electrodes, the at least one organic EL device being formed on a substrate. In particular, sealing means is provided for sealing the at least one organic EL device through a resin layer formed on the at least one organic EL device, while the resin layer is formed by applying or putting on a high molecular elastomer to cover up an entire surface of the at least one organic EL panel device.

According to another aspect of the present invention, there is provided a method of manufacturing an organic EL panel including at least one organic EL device formed by interposing an organic material layer containing a luminescent functional layer between at least one pair of electrodes, said at least one organic EL device being formed on a substrate. In particular, an amount of high molecular elastomer is applied to cover up an entire surface of the at least one organic EL device, a sealing substrate is pressed to the high molecular elastomer so as to be bonded to the substrate.

According to a further aspect of the present invention, there is provided a method of manufacturing an organic EL panel including at least one organic EL device formed by interposing an organic material layer containing a luminescent functional layer between at least one pair of electrodes, said at least one organic EL device being formed on a substrate. In particular, a sheet-like high molecular elastomer is put on to cover up an entire surface of the at least one organic EL device, a sealing substrate is pressed to the high molecular elastomer so as to be bonded to the substrate.

According to a still further aspect of the present invention, there is provided a method of manufacturing an organic EL panel including at least one organic EL device formed by interposing an organic material layer containing a luminescent functional layer between at least one pair of electrodes, said at least one organic EL device being formed on a substrate. In particular, an amount of high molecular elastomer is applied to cover up an entire surface of the at least one organic EL device, a sealing film is formed on the high molecular elastomer so as to seal the at least one organic EL device.

According to one more aspect of the present invention, there is provided a method of manufacturing an organic EL panel including at least one organic EL device formed by interposing an organic material layer containing a luminescent functional layer between at least one pair of electrodes, said at least one organic EL device being formed on a substrate. In particular, a sheet-like high molecular elastomer is put on to cover up an entire surface of the at least one organic EL device, a sealing film is formed on the high molecular elastomer so as to seal the at least one organic EL device.

### BRIEF DESCRIPTION OF THE DRAWINGS

These and other objects and advantages of the present invention will become clear from the following description with reference to the accompanying drawings, wherein:

FIG. 1 is an explanatory view showing the structure of an organic EL panel formed according to one embodiment of the present invention;

FIG. 2 is an explanatory view showing a method of manufacturing an organic EL panel according to an embodiment of the present invention;

FIG. 3 is an explanatory view showing another method of manufacturing an organic EL panel according to another embodiment of the present invention;

FIG. 4 is an explanatory view showing the structure of an organic EL panel formed according to another embodiment of the present invention; and

FIG. 5 is an explanatory view showing the structure of an organic EL panel formed according to a further embodiment of the present invention.

### DETAILED DESCRIPTION OF THE PREFERRED EMBODIMENTS

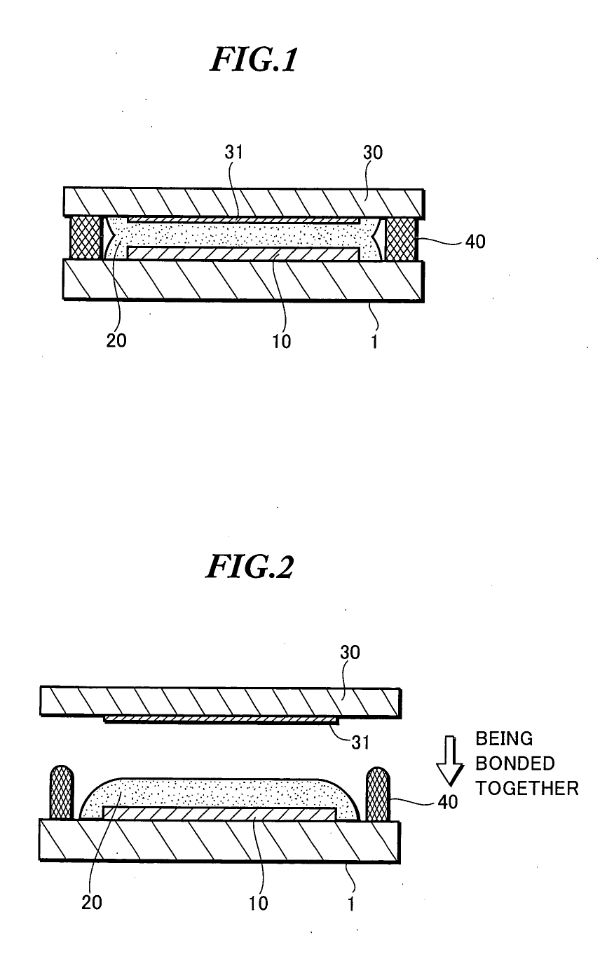

The present invention will be described in the following with reference to the accompanying drawings. FIG. 1 is an explanatory view showing the structure of an organic EL panel formed according to one embodiment of the present invention. As shown, the organic EL panel comprises a substrate 1 and an organic EL device section 10 consisting of organic EL device(s). The organic EL device section 10 includes one or more organic EL devices each involving a pair of electrodes and an organic material layer containing a luminescent functional layer, with the organic material layer being interposed between the pair of electrodes. However, if it is required to display a picture having a high precision, the organic EL panel needs to be formed in a manner such that a plurality of organic EL devices are arranged with a high density.

A resin layer 20 is formed onto the organic EL device section 10, and a sealing cover 30 serving as sealing means is bonded on to the substrate 1 by virtue of an adhesives layer 40, thereby covering up the organic EL device section 10. Further, if necessary, a desiccating member 31 may be bonded to the sealing cover 30 on its one surface facing the organic EL device section 10.

In the organic EL panel formed according to the present embodiment of the invention, the resin layer 20 is formed of a high molecular elastomer which is applied to or put on the entire surface of the organic EL device section 10. Here, so-called high molecular elastomer is a general term meaning all sorts of high molecular elastic materials each exhibiting a rubber-like elasticity when at or near the room temperature. However, such a high molecular material is required to be an elastic resin material which has already been in its polymerized state when being applied to or put on the organic EL device section, thereby allowing itself to be distinguishable from those materials which, after being sealed, will be polymerized due to a hardening treatment using a light, a heat or the like. Specifically, such a high molecular elastomer is also required to be flowable at a low temperature and have a sufficient shape adaptability under a low pressure in order to achieve a desired deformation.

In practice, as the above-mentioned high molecular elastomer, it is allowed to use an acrylic system polymer, a polyamide system polymer, a urethane system polymer, a polyester system polymer, an olefin system polymer, a diene system polymer, a hydrogenated product of a diene system polymer, a diene system block copolymer, a hydrogenated product of a diene system block copolymer, a silicone system polymer, a fluorine system polymer, a vinyl chloride system polymer, etc. Actually, these substances may be used singly or in combination including two or more of them.

Moreover, according to the present embodiment of the invention, in order to obtain a molded body having a higher flexibility, it is preferable for the above-mentioned high molecular elastomer to contain a liquefied material. As such liquefied material, it is suitable to use a softener, a plasticizer, a lubricant, and a liquefied polymer.

Moreover, the above-mentioned high molecular elastomer is preferred to be transparent. If its thickness is 10 micrometers, its haze is preferably to be less than 5%, more preferably 4.5% or less, further preferably 4% or less. Further, an all light transmittance of the high molecular elastomer is preferable to be 90% or more, more preferably 91% or more, further preferably 92% or more.

In addition, the above-mentioned high molecular elastomer is required to have a flexibility, and its shear storage elastic modulus (G′) obtainable in a dynamic viscoelasticity measurement at 30° C. and 1 Hz are preferably 1×10¹⁰ dyn/cm² or less and 1 dyn/cm² or more.

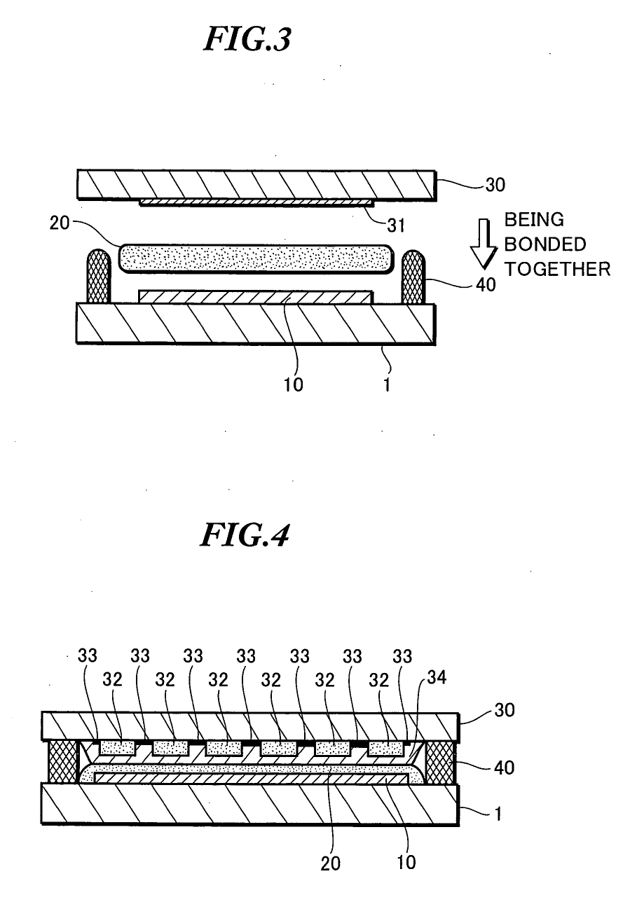

FIG. 2 and FIG. 3 are explanatory views showing a method of manufacturing an organic EL panel according to the present invention. In an embodiment shown in FIG. 2, an amount of high molecular elastomer is applied to the substrate 1, in a manner such that the entire surface of the organic EL device section 10 may be covered up by the elastomer, whereby forming a resin layer 20 thereon. Then, the sealing cover 30 is pushed downwardly from above the resin layer 20 so as to be bonded to the substrate 1. Namely, after forming the organic EL device section 10 on the substrate 1, an adhesive layer 40 is formed along the perimeter of the organic EL device section 10, while at the same time an mount of high molecular elastomer flowable at low temperature is applied to the organic EL device section 10. Meanwhile, the desiccating member 31 is bonded to one surface (inner surface) of the sealing cover 30. Afterwards, one surface (bonded with the desiccating member 31) of the sealing cover 30 is caused to face one surface (bonded with the organic EL device section 10) of the substrate 1, so that the sealing cover 30 and the substrate 1 may be bonded together in a manner such that there would be no clearance to be formed between the organic EL device section 10 and the desiccating member 31 by pressing the two members toward each other. At this time, the temperature of the substrate and the temperature of the high molecular elastomer are set at 100° C. or lower in order to prevent any possible damage (caused by a high temperature) to the organic EL device section 10. Moreover, in order to obtain a further improved effect, it is preferred to set the temperatures at 50° C. or lower, more preferably 30° C. or lower.

In an embodiment shown in FIG. 3, a sheet-like resin material consisting of a high molecular elastomer is used to cover up the entire surface of the organic EL device section 10, whereby forming a resin layer 20 lying thereon. Then, the sealing cover 30 is pushed downwardly from above the resin layer 20 so as to be bonded to the substrate 1. Namely, after forming the organic EL device section 10 on the substrate 1, an adhesive layer 40 is formed along the perimeter of the organic EL device section 10, while at the same time the organic EL device section 10 is covered up with the sheet-like high molecular elastomer. Meanwhile, the desiccating member 31 is bonded to one surface (inner surface) of the sealing cover 30. Afterwards, one surface (bonded with the desiccating member 31) of the sealing cover 30 is caused to face one surface (bonded with the organic EL device section 10) of the substrate 1, so that the sealing cover 30 and the substrate 1 may be bonded together in a manner such that there would be no clearance to be formed between the organic EL device section 10 and the desiccating member 31 by pressing the two members toward each other. In fact, using such sheet-like high molecular elastomer makes it possible to ensure an acceptable workability and an improved operation efficiency as compared with the above-discussed method involving resin application.

In addition, the above-discussed embodiment is allowed to be such that the substrate 1 is formed into a substrate having a light transmittance, thereby obtaining a bottom emission display panel which allows light to be taken from the substrate side. Alternatively, the sealing cover 30 is formed into a member having a light transmittance, thereby obtaining a top emission type display panel which allows light to be taken from the sealing cover side. Particularly, with regard to the top emission type display panel, if the resin layer 20 consisting of a high molecular elastomer is formed into a transparent layer, it is possible to ensure an acceptable light emission.

In using the method of manufacturing an organic EL panel according to the present invention, since an internal space over the organic EL device section 10 is filled with the resin layer 20 consisting of a high molecular elastomer, an internal clearance between the substrate 10 and the sealing cover 30 can be removed, thereby reducing some deterioration factors such as oxygen and moisture contained in the internal clearance. Moreover, it is possible to intercept, by virtue of the resin layer 20, some deterioration factors such as moisture and the like generated from the adhesive layer 40. In this way, even if an amount of desiccating member located between the substrate 1 and the sealing cover 30 is reduced or even removed, it is still possible to effectively inhibit the deterioration of the organic EL device(s).

Furthermore, when manufacturing a top emission type display panel which allows light to be taken from the sealing cover 30 side, it is possible to obtain a uniform refraction index of a light emission path by adjusting the refraction index of the resin layer 20, thereby making it possible to eliminate an optical deviation between emission aperture on the sealing cover 30 side and aperture on the light emission surface of each organic EL device, thus avoiding a color deviation when trying to produce a color display panel.

Moreover, since the resin layer 20 is formed of a high molecular elastomer which is not necessary to receive a hardening treatment after sealing, the organic EL device section 10 can be prevented from being emitted by alight or a heat used in a conventional hardening treatment, thereby making it possible to avoid a problem of organic EL device deterioration caused by such a light or heat emission. Meanwhile, it is also possible to eliminate a problem of organic EL device deterioration which is possibly caused by un-reacted components remaining after the hardening treatment. Furthermore, since there would be no hardening treatment after sealing process, it is allowed to simplify the manufacturing process, thereby improving the productivity of display panels.

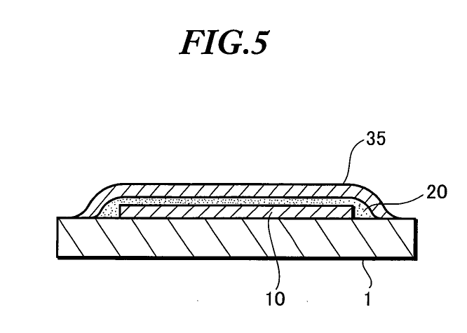

FIG. 4 is an explanatory view showing an organic EL panel formed according to another embodiment of the present invention. In this embodiment, a plurality of elongated color filter layers 32 are formed on the inner surface (facing the substrate 1) of the sealing cover 30, and covered by a light transmissible moisture capturing film 34. However, since this embodiment differs from the above-described embodiment only in the structure on the sealing cover 30 side which is different from that of the foregoing embodiment, like parts in other portions of the present embodiment are represented by the like reference numerals, with the same explanation being omitted.

In order to obtain an organic EL panel according to the present embodiment, the sealing cover 30 is formed of a transparent material, while a black matrix 33 having a plurality of apertures formed corresponding to the luminescent areas of organic EL devices are formed on one (inner) surface of the sealing cover 30, followed by forming the color filter layers 32 facing the luminescent areas of the organic EL devices. Subsequently, the moisture capturing film 34 having a predetermined light transmittance is formed to cover the color filter layers 32.

On the other hand, what are formed on the substrate 1 side are the organic EL device section 10, the resin layer 20, and the adhesive layer 40, which are similar to those in the above-described embodiments (see FIGS. 2 and 3). Afterwards, the substrate 1 and the sealing cover 30 are bonded together by being pressed toward each other in a manner such that the moisture capturing film 34 faces the resin layer 20, with the resin layer 20 being tightly attached to the moisture capturing film 34.

According to the present embodiment, it is possible to obtain the same function and effect as those obtainable in the above-described embodiments. Meanwhile, it is also possible to eliminate a color deviation between the luminescent areas of the organic EL device section 10 and the apertures of the color filter layers 32 by adjusting the refraction index of the resin layer 20, thereby making it possible to perform an acceptable color displaying.

FIG. 5 is an explanatory view showing anorganic EL panel formed according to a further embodiment of the present invention. According to this embodiment, a sealing film 35 is formed to cover up an organic EL device section 10 formed on the substrate 1, with the resin layer 20 interposed between the sealing film 35 and the organic EL device section 10. The resin layer 20 is formed by applying or disposing (putting on) a high molecular elastomer in a manner such that the entire surface of the organic EL device section 10 can be covered up by the elastomer layer.

In order to obtain an organic EL panel according to the present invention, at first the organic EL device section 10 is formed on the substrate 1. Then, as shown in FIG. 2 or FIG. 3, an amount of a high molecular elastomer is applied to cover up the entire surface of the organic EL device section 10. Alternatively, a sheet-like resin layer consisting of a high molecular elastomer is disposed (put on) to cover up the organic EL device section 10 in a manner such that the entire surface of the organic EL device section 10 is sealed up, thereby forming the resin layer 20. Subsequently, the sealing film 35 is formed on the resin layer 20.

According to the present embodiment, since it is possible to dispense with the sealing cover 30 used in the foregoing embodiment, it is possible to obtain a display panel light in weight and having a thin thickness, and to omit a step of preparing the sealing cover 30 (such as bonding the desiccating member 31 onto the sealing cover 30) as well as a step of bonding together the sealing cover 30 and the substrate 1, thereby simplifying the manufacturing process. Further, by arbitrarily selecting a state of the substrate 1, it is possible to form various display panels in different states. In particular, by making the substrate 1 into a flexible substrate, it is possible for a display panel to be attached to a curved surface, thereby realizing a paper panel.

In addition, similar to the above-described embodiment, since the resin layer 20 is formed of a high molecular elastomer which does not have to be subjected to a hardening treatment after sealing, it is possible to avoid the deterioration of organic EL device caused by light and heat applied in conventional hardening treatment, thereby eliminating the problem of organic EL device deterioration caused by some residual un-reacted components. Furthermore, since no hardening treatment is carried out after sealing, it is allowed to simplify the manufacturing process, thereby improving the productivity of display panel.

Next, description will be given to explain in more detail various parts forming an organic EL panel of the present embodiment, in line with a process for manufacturing the display panel.

First, anorganic EL device section 10 is formed on the substrate 1 by using one of various conventional methods. However, a driving method for driving the organic EL device section 10 can be either a passive driving or an active driving.

The substrate 1 can be formed into any shape such as a flat plate, a flexible film, and a curved sheet, using a material which may be glass, plastic, quartz, or metal. If an organic EL display panel is a bottom emission type in which light is taken from the substrate side, it is preferable for the substrate 1 to be formed of a transparent or semi-transparent material. On the other hand, if an organic EL display panel is a top emission type in which light is taken from the sealing cover side, it is allowable for the substrate 1 to be formed by one of various usable materials regardless of their transparencies. For example, it is possible to use a paper coated with an insulating material, or to use quartz, stone, wood or metal.

In detail, the organic EL device section 10 includes at least one pair of electrodes consisting of at least one upper electrode and at least one lower electrode, and an organic material layer containing a luminescent functional layer and interposed between the upper and lower electrodes. Here, one of each pair of electrodes is set as a cathode while the other is set as an anode. Practically, the anode is formed of a material having a higher work function than the cathode, i.e. a transparent conductive film such as a metal film which may be chromium (Cr), molybdenum (Mo), nickel (nickel), or platinum (Pt), and a metal oxide film such as ITO, IZO or the like. On the other hand, the cathode is formed of a material having a lower work function than the anode, which may be a metal film such as aluminum (Al) and magnesium (Mg), an amorphous semiconductor such as a doped polyaniline and a doped polyphenylene vinylene, or an oxide such as Cr₂O₃, NiO, and Mn₂O₅. Moreover, where both the lower and upper electrodes are all formed of transparent materials, it is required that a reflection film is provided on one electrode side opposite to the light emission side.

As an example of an electrode structure forming a passive driving type display panel, an ITO film or the like is formed on the substrate 1 by means of vapor deposition, sputtering or the like. Then, a patterning process such as photolithography or the like is carried out to form a lower electrode pattern including a plurality of electrode strips.

Subsequently, an insulating film consisting of an insulating material such as polyimide, SiN, and SiO₂ is formed in a manner such that the luminescent area of the lower electrode pattern is divided into a plurality of sections. In more detail, at first, a spin coating process is carried out to form an insulating film having a predetermined thickness on the lower electrode pattern. Then, a light exposure mask is used to perform a light exposure and a development processing, thereby forming an insulating film having a predetermined pattern. Specifically, the insulating film is laminated to partially cover the exposed portions of the substrate located among the lower electrode strips and both ends of each lower electrode strip, thereby forming strips at a predetermined interval in orthogonal relation with the lower electrode strips. In this way, the aperture portions of the insulating film serve to divide the luminescent area of the organic EL device section.

Next, partition walls are formed on the insulating film in order that the mutually adjacent upper electrode strips are electrically insulated and that the above mask can be used as a shadow mask. Here, although the partition walls are preferred to be formed into inverted tapered shapes, they are allowed to have any desired shapes provided that it is possible to achieve the above-mentioned advantages. Further, when the upper electrode strips are patterned by the shadow mask or the like and formed by virtue of vapor deposition, the partition walls are allowed to be omitted.

Actually, the partition walls can be formed in accordance with a method which will be described below. Namely, an insulating material such as a photosensitive resin is applied to the insulating layer by means of spin coating in a manner such that the thickness of the photosensitive resin becomes thicker than the sum of the organic material layer and an upper electrode strip. Then, an ultraviolet ray or the like is used to irradiate the photosensitive resin through a photo-mask having a predetermined pattern including a plurality of apertures, thereby forming inverted tapered partition walls by making use of a difference in development velocity which is caused by a difference in light exposure amount in the thickness direction of various layers.

The organic material layer formed on the lower electrode strips is a layer consisting of an organic compound having a single layer structure or a multiple layer structure, each containing a luminescent functional layer. In practice, such an organic material layer may be formed by means of a coating process such as spin coating and dipping, or a wet process such as ink-jet printing and screen printing, or a dry process such as vapor deposition and laser transferring.

Generally, the structure of such an organic material layer includes successively, from the anode side towards the cathode side, a positive hole transporting layer, a luminescent layer, and an electron transporting layer. On the other hand, each of the positive hole transporting layer, the luminescent layer, and the electron transporting layer may be provided not only in the form of a single layer structure but also in the form of a multiple layer structure. Further, it is also allowed to omit either one or both of the positive hole transporting layer and the electron transporting layer. Moreover, if necessary, it is also possible to intercalate an organic material layer such as a hole injection layer and an electron injection layer. Practically, the positive hole transporting layer, the luminescent layer, and the electron transporting layer can be formed by conventional materials (irrespective of whether they are high molecular materials or low molecular materials) in view of their luminescent colors.

Moreover, with regard to a luminescent material forming the luminescent layer, it is allowed to use a material which presents luminescence (fluorescence) at the time of returning from a singlet excited state to a ground state, and it is also possible to use a material which presents luminescence (phosphorescence) at the time of returning from a triplet excited state to a ground state.

In the case of a passive driving type display panel, an upper electrode section includes a plurality of stripe-like electrodes arranged in a direction orthogonal to the lower electrode strips, with the organic material layer interposed between the upper and lower electrode strips. In this way, a plurality of organic EL devices arranged in a dot matrix arrangement are formed at the intersections of the upper electrodes (strips) and the lower electrodes (strips).

The organic EL device section 10 can be formed into not only a monochromatic luminescent structure but also a multi-color luminescent structure. The multi-color luminescent structure can be realized by a discriminatory coating process capable of forming luminescent functional layers of at least two colors, including a process of forming three kinds of luminescent functional layers corresponding to colors R, G, and B, or can be realized by the CF method or the CCM method in which a color conversion layer based on a color filter or a fluorescent material is incorporated into a monochromatic organic luminescent functional layer of white color or blue color. Alternatively, the multi-color luminescent structure can be realized by a photo breeching method in which an electromagnetic wave is used to irradiate the luminescent area of a monochromatic luminescent functional layer, thereby effecting a plurality of light emissions. Alternatively, an organic luminescent functional layer interposed between electrode pairs on the substrate may be formed into not only a single-layer structure, but also a multi-layer structure including a plurality of layers laminated one upon another capable of multi-color light emission. For example, it is possible to form a structure of substrate/lower electrode section/first organic luminescent functional layer/first intermediate electrode section/second organic luminescent functional layer/second intermediate electrode section/third organic luminescent functional layer/upper electrode section.

Then, a high molecular elastomer is applied or put on so as to form the resin layer 20 in a manner such that the entire surface of the organic EL device section 10 may be covered up (as shown in FIG. 2 and FIG. 3).

Further, an adhesive layer 40 is formed along the perimeter of the organic EL device section 10. Practically, such an adhesive layer 40 may be thermal-setting type, chemical-setting type (two liquid mixing) or light (ultraviolet) setting type. The desired adhesive layer may be formed by applying one of these adhesive agents using a dispenser or the like. As adhesive agents, it is allowed to use an acryl resin, an epoxy resin, a polyester, a polyolefin, and the like.

If necessary, the aforementioned desiccating member 31 such as BaO, or the black matrix 33, the color filter layer 32, and the moisture capturing film 34 may be provided on the sealing cover 30 in a manner such that they are facing the organic EL device section 10, thereby allowing the sealing cover 30 and the substrate 1 to be bonded together. Further, a predetermined pressure is applied from the sealing cover 30 side to effect a tight contact between the substrate 1 and the sealing cover 30 so that there would be no clearance between the two members by virtue of deformation of the high molecular elastomer.

Here, as the sealing cover 30, it is allowed to use a plate having an internal recess formed by performing a processing such as press molding, etching, and blasting on a flat glass plate. However, it is also possible to form an internal space between the flat glass sealing cover 30 and the substrate 1 by using a spacer made of glass or plastic.

In case where the sealing layer 35 is employed, such sealing layer 35 may be formed by laminating a single protection layer or a plurality of protection layers on the surface of the resin layer 20 consisting of a high molecular elastomer. In fact, such a sealing layer 35 may be formed of either an inorganic substance or an organic substance by means of CVD method or ion-plating method. As an inorganic substance, it is allowed to use a nitride such as SiN, AlN, GaN and the like, an oxide such as SiO, Al₂O₃, Ta₂O₅, ZnO, GeO and the like, another sort of nitride such as SiN, an oxidized nitride such as SiON, an carbonized nitride such as SiCN, a metal fluorine compound, and a metal film. Further, as an organic substance, it is allowed to use an epoxy resin, an acryl resin, polyparaxylene, fluorine system macromolecules (perfluoro olefin, perfluoro ether, tetrafluoro ethylene, chlorotrifluoro ethylene, dichloro-difluoro ethylene, etc.), metal alkoxides (CH₃OM, C₂H₅OM, etc.), a polyimide precursor, and a perylene system compound. A laminating manner and a material to be actually used in such case may be properly selected when designing an organic EL panel.

Moreover, the sealing film 35 may be a glass film formed by applying a glass material. At this time, since it is necessary to employ a low-temperature glass coating technique, an organic metal compound may be organo polysiloxane, a halogen catalyst may be fluorine-oxide ammonium, a mixed solvent may be water, methanol, ethanol or isopropanol, so that a reaction product may be obtained by using these reactants. Then, the reaction product is applied to form a sealing film while the substrate 1 is pre-dried at a temperature of 40 to 100° C. Subsequently, a baking process is carried out in a low water content state at a temperature of 120° C. for 30 minutes, thereby obtaining a glass film serving as the sealing film 35.

Using the high molecular elastormer covering up the organic EL device section 10, it is possible to eliminate a damage to the organic EL device section 10 when forming the sealing film 35. Namely, although the organic EL device section 10 will be wounded when the sealing film 35 is formed by using a film formation method such as sputtering, such a damage on the organic EL device section 10 can be alleviated by interposing as a buffer layer the resin layer 20 consisting of a high molecular elastomer. In deed, considerable time is needed in obtaining a necessary thickness for the buffer layer when the CVD method or the like is used to form the buffer layer, it is possible to reduce an operation time required in forming the resin layer 20 consisting of a high molecular elastomer by means of coating or sealing, thereby obtaining an improved productivity. Moreover, since there would be no scattering of materials which would otherwise be caused in carrying out a film formation method such as the CVD method or the like, it is allowed to make full use of the related materials and reduce the manufacturing cost.

According to the above-described embodiment, an organic EL panel may be formed by interposing the resin layer 20 between the sealing cover 30 or the sealing film 35 and the substrate 1 on which the organic EL device section 10 has been formed, making it possible to dispense with the hardening treatment of the resin layer 20, thereby avoiding an organic EL device deterioration possibly caused by the hardening treatment. Meanwhile, it is also possible to simplify the manufacturing process. In addition, by eliminating the remaining un-treated components based on the resin hardening treatment, it is possible to avoid some organic EL device deterioration factors remaining within the internal space of the display panel.

While there has been described what are at present considered to be preferred embodiments of the present invention, it will be understood that various modifications may be made thereto, and it is intended that the appended claims cover all such modifications as fall within the true spirit and scope of the invention.

1. An organic EL panel including at least one organic EL device formed by interposing an organic material layer containing a luminescent functional layer between at least one pair of electrodes, said at least one organic EL device being formed above a substrate,
wherein sealing means is provided for sealing the at least one organic EL device through a resin layer formed on the at least one organic EL device,
wherein said resin layer is formed by applying or putting on a high molecular elastomer to cover up an entire surface of the at least one organic EL panel device.

2. The organic EL panel according to claim 1, wherein the sealing means is a sealing substrate bonded to the substrate through an adhesive layer.

3. The organic EL panel according to claim 1, wherein a color filter layer is formed on an internal surface of the sealing substrate, and is covered up by a light-transmissible moisture capturing film.

4. The organic EL panel according to claim 1, wherein the sealing means is a sealing film formed on the resin layer.

5. The organic EL panel according to any one of claims 1 to 4, wherein the sealing means and the resin layer have a light permeability, and are capable of taking light from the sealing means side.

6. A method of manufacturing an organic EL panel including at least one organic EL device formed by interposing an organic material layer containing a luminescent functional layer between at least one pair of electrodes, said at least one organic EL device being formed on a substrate,
wherein an amount of high molecular elastomer is applied to cover up an entire surface of the at least one organic EL device, a sealing substrate is pressed to the high molecular elastomer so as to be bonded to the substrate.

7. A method of manufacturing an organic EL panel including at least one organic EL device formed by interposing an organic material layer containing a luminescent functional layer between at least one pair of electrodes, said at least one organic EL device being formed on a substrate,
wherein a sheet-like high molecular elastomer is put on to cover up an entire surface of the at least one organic EL device, a sealing substrate is pressed to the high molecular elastomer so as to be bonded to the substrate.

8. A method of manufacturing an organic EL panel including at least one organic EL device formed by interposing an organic material layer containing a luminescent functional layer between at least one pair of electrodes, said at least one organic EL device being formed on a substrate,
wherein an amount of high molecular elastomer is applied to cover up an entire surface of the at least one organic EL device, a sealing film is formed on the high molecular elastomer so as to seal the at least one organic EL device.

9. A method of manufacturing an organic EL panel including at least one organic EL device formed by interposing an organic material layer containing a luminescent functional layer between at least one pair of electrodes, said at least one organic EL device being formed on a substrate,
wherein a sheet-like high molecular elastomer is put on to cover up an entire surface of the at least one organic EL device, a sealing film is formed on the high molecular elastomer so as to seal the at least one organic EL device.
